(19) United States
(12) Patent Application Publication
(10) Pub. No.: US 2024/0409436 A1
(43) Pub. Date: Dec. 12, 2024

(54) METHOD FOR IMPROVING CROSS-FLOW FILTRATION AND CROSS-FLOW FILTRATION SYSTEM

(71) Applicant: Roche Diagnostics Operations, Inc., Indianapolis, IN (US)

(72) Inventors: Carlos Munoz, Penzberg (DE); Hans Zahn, Peiting (DE)

(21) Appl. No.: 18/810,797

(22) Filed: Aug. 21, 2024

Related U.S. Application Data
(63) Continuation of application No. PCT/EP2023/054272, filed on Feb. 21, 2023.

(30) Foreign Application Priority Data
Feb. 21, 2023 (EP) 22157842.0

(51) Int. Cl. C02F 1/00; C02F 103/00

(52) U.S. Cl. CPC C02F 1/001; C02F 2103/003; C02F 2201/005; C02F 2209/001; C02F 2301/022; C02F 2301/06

(57) ABSTRACT

A method of cross-flow filtering wastewater from a diagnostic apparatus or a laboratory analyser, wherein the wastewater comprises nanoparticles and/or microparticles, and the wastewater is streaming in a laminar flow across a surface of a filter membrane, the method comprising: (a) streaming the wastewater across the surface of the filter membrane with a flow rate, so that the flow of the wastewater is a laminar flow with a Reynolds number (Re) of smaller than 500; (b) streaming the wastewater in pulse cycles across the surface of the filter membrane, wherein each pulse cycle comprises one active phase in which the wastewater is under a duty pressure and one inactive phase in which the wastewater is under an inactive pressure, wherein the inactive pressure is no more than 10% of the duty pressure and the active phases have a duration of greater than 50% of the corresponding pulse cycles; and (c) separating the nanoparticles and/or microparticles from the wastewater when the wastewater passes through the filter membrane. Also described is a cross-flow filtration system configured for performing the method.

### FIELD OF THE INVENTION

The invention relates to a method of cross-flow filtering wastewater from a diagnostic apparatus or a laboratory analyser, wherein the wastewater comprises nanoparticles and/or microparticles, and where the wastewater is streaming in a laminar flow across a surface of a filter membrane. The invention also relates to a cross-flow filtration system for performing the method. The invention is also concerned with a computer program for performing the method and with a computer-readable medium storing the computer program.

### BACKGROUND

The laboratory diagnostic industry uses reagents containing small particles having particle sizes smaller than 5 mm, e.g. nanoparticles and/or microparticles. The wastewater produced by this industry contains these small particles, which are potentially harmful to the environment because of the materials from which they are made (e.g. microplastic). They also tend to be highly adsorbent and may cause damage because they can transfer contaminants to and from the environment. These particles differ from the particulate waste produced by other industries in that they have a well-defined composition and a highly uniform particle size. Accordingly, efficient removal of particles from the wastewater of a laboratory analyser is challenging.

Filtration techniques are often used to remove particles from liquids. Cross-flow filtration (also known as tangential flow filtration) is a type of filtration where the liquid for filtration is passed across a filter membrane, rather than directly into the filter as in dead-end filtration. Material in the liquid that is smaller than the pore sized of the filter membrane will pass through the membrane to produce a permeate. The liquid is passed across the filter membrane at a positive pressure relative to the permeate side. It is this positive pressure that provides the main driving force for the cross-flow filtration process. The difference in pressure between the two sides of the filter membrane (known as the feed/retentate side and the permeate side) is measured as the transmembrane pressure (TMP).

Many cross-flow filtration processes involve a turbulent flow (e.g. a Reynolds number of about 2000 or more) of liquid being passed over the filter membrane. In such processes, the flow of liquid near the surface of the filter membrane is turbulent, which can prevent particulates from settling on the surface to form a filter cake that blocks the membrane's pores. Turbulent flows of liquid in cross-flow filtration are generally produced in filtration apparatus where the flow of the liquid is very high. Such flows are typically produced by pumps having a high-power output. These pumps tend to be large in size and have high energy consumption.

When cross-flow filtration is performed with a lower flow rate of liquid, then a laminar flow may pass over the surface of the filter membrane. Due to the low tangential flow velocity near the surface of the filter membrane associated with laminar flows, a problem is that the filter membrane is susceptible to becoming obstructed by particulates, such as when they agglomerate to form a filter cake on the surface of the filter membrane. When this happens, it is necessary to stop filtration to replace a blocked filter membrane with an unblocked one. Removal of obstructions from the filter membrane is necessary before it can be reused, but this can result in damage being caused to the membrane due to its delicate nature. This is undesirable because the filter membrane is an expensive part of the cross-flow filtration system.

### SUMMARY OF THE INVENTION

In a first aspect, the invention provides a method of cross-flow filtering wastewater from a diagnostic apparatus or a laboratory analyser, wherein the wastewater comprises nanoparticles and/or microparticles, and the wastewater is flowing in a laminar flow across an inner surface of a tubular filter membrane (25) having an inlet and an outlet at a flow rate such that a Reynolds number (Re) of the flowing wastewater is smaller than 500;
wherein the wastewater flows in pulse cycles across the inner surface of the tubular filter membrane (25) from the inlet towards the outlet, wherein each pulse cycle comprises one active phase (A′) in which the wastewater is under a duty pressure at the inlet and one inactive phase (I) in which the wastewater is under an inactive pressure at the inlet, wherein the inactive pressure is no more than 10% of the duty pressure and the active phases have a duration of greater than 50% of the corresponding pulse cycles; and
wherein a filtrate portion of the wastewater passes across the tubular filter membrane (25) and wherein the nanoparticles and/or microparticles are separated from the filtrate portion of the wastewater by the tubular filter membrane (25).

The invention is concerned with cross-flow filtration where a laminar flow of liquid, in this case wastewater from a diagnostic apparatus or a laboratory analyser, is passed or streamed over the surface of a filter membrane. The flow rate of liquid passing over the filter membrane is relatively low, especially when compared to systems employing a turbulent flow. As explained further below, the cross-flow filtration methods and system of the invention are particularly suitable for use with a diagnostic apparatus or a laboratory analyser to remove small particles from the wastewater produced by such devices.

It has surprisingly been found that by streaming the wastewater in pulse cycles across the surface of the filter membrane that blockage of the filter membrane can be reduced or prevented during cross-flow filtration. This leads to a considerable improvement in the performance and efficiency of the cross-flow filtration technique. Cross-flow filtration can be carried out for longer periods of time, while maintaining a high flow of permeate through the filter membrane. It reduces the need for regularly stopping filtration to unblock and clear the filter membrane. It may also prolong the lifetime of the filter membrane.

It will be understood that, in contrast to known cross-flow filtration methods, embodiments of the present invention do not superimpose oscillations or flow pulses on an underlying continuous flow. Rather, embodiments of the present invention impose a flow regimen that alternates between the active phase and the inactive phase as defined. Embodiments of the present invention may impose a flow that does not include any backwash or reverse flow across the filter membrane. Embodiments of the present invention may impose a flow where the transmembrane pressure is at or above zero at all times. Moreover, embodiments of the present invention apply pulse cycles having a much lower frequency than used in known cross-flow filtration methods, and with flows at very low Reynolds numbers of less than 500.

Energy is consumed by producing a flow or stream of wastewater that will pass over the filter membrane, such as when using a pump to drive the wastewater around a cross-flow filtration system. When the wastewater is streamed in pulse cycles, then energy is mainly consumed during the active phase of each pulse cycle and is saved during the inactive phase. This avoids the continuous consumption of energy and improves the efficiency of the filtering process.

The use of a single pump in embodiments of the present invention, for example a membrane pump, to implement a flow regimen comprising only alternating active and inactive phases, means that less energy is required than in prior art systems where a continuous streaming flow is pumped through a filter device and flow oscillations are superimposed on the underlying continuous streaming flow to produce positive and negative flow directions or cycles. Such prior art systems typically require at least two pumps, one to generate the continuous streaming flow and one to superimpose the flow oscillations, and therefore use more energy.

Embodiments of the present invention do not impose an alternative positive and negative flow, but instead alternate between a gentle positive flow (active phase) and substantially no or very little flow (inactive phase). The transmembrane pressure may be greater than or equal to zero at all times, with the transmembrane pressure being greater during the active phase than in the inactive phase.

Embodiments of the present invention, using a laminar flow with a maximum Reynolds number of less than 500, avoid cavitation or backwash in the flow of wastewater through the tubular filter membrane. Avoidance of cavitation or backwash is promoted by keeping the transmembrane pressure at or above zero at all times. Avoidance of cavitation or backwash may result in low mechanical stress to the filter membrane. This may prolong the useful lifetime of the filter membrane.

The gentle laminar flow and the low pulse cycle frequency of embodiments of the present invention mean that shear effects on any particulate build-up (filter cake) on the inside of the tubular filter membrane are much less than in prior art systems. It is currently thought that embodiments of the present invention reduce the build-up of particulates (filter cake) primarily through diffusion of the particles into the wastewater within the tubular filter membrane during inactive phases of the cycle.

In the invention, the active phase has a duration of greater than 50% of the corresponding pulse cycle. The inventors of the present invention have recognized that, on the one hand, the inactive phase may reduce or prevent formation of filter cake on the filter membrane and the surface of the membrane can be kept clean. On the other hand, the inventors have also realized that the longer the active phase of the pulse cycles and the shorter the inactive phase, the more throughput is possible, as the effective conveying time is longer per pulse. In other words, more permeate is achieved at the same pressure when the duration of the active phase is longer than the duration of inactive phase in the pulse cycles. Thus, the extension of the active phase of the pulse cycles compared to the inactive phase results in an increase in the efficiency of the filtering process and an overall reduction in energy consumption.

The inventors assume that this effect results from the following relationships: During the inactive phase, some of the particles that form the filter cake go back into solution. The longer the inactive phase, the more particles dissolve in the liquid. The dissolved particles are then washed away in the active phase. With laminar flow, it is possible for a large proportion of the dissolved particles to be washed away and only a smaller proportion to be incorporated back into the filter cake. Therefore, the inactive phase should not be arbitrarily short. This is also valid for the recovery phase according to step (A), as described below.

In some embodiments, the method further comprises:
(A) applying a recovery phase in which there is nearly no wastewater flow and there is nearly no transmembrane pressure; and
(B) applying a cleaning phase in which the wastewater is streamed across the surface of the filter membrane with nearly no transmembrane pressure.

The recovery phase and the cleaning phase may be repeated several times.

Steps (A) and (B) may be implemented for cleaning and/or recovering a filter membrane. The combination of a recovery phase and a cleaning phase can be used when the filter membrane shows signs of fouling, such as to restore the flow rate of permeate through the filter membrane.

Cross-flow filtration according to the invention may be performed until the filter membrane shows signs of fouling. Steps (A) and (B) may then be performed to clean and/or restore the filter membrane for further use.

In a second aspect, the invention provides a cross-flow filtration system for filtering wastewater from a diagnostic apparatus or a laboratory analyser, wherein the wastewater comprises nanoparticles and/or microparticles, by a laminar flow across an inner surface of a tubular filter membrane having an inlet and an outlet, the system comprising:
a filter module comprising the tubular filter membrane;
a pressure source for streaming wastewater across the surface of the tubular filter membrane from the inlet towards the outlet;
a sensor for detecting a flow rate of the wastewater;
a controller connected to the sensor and configured to control the pressure source to carry out a method according to the first aspect; and
a flow inhibitor being disposed downstream of the filter module on a retentate side thereof, for providing a flow resistance during active phases of pulse cycles.

As the flow rate of wastewater passed over the filter membrane is relatively low, the cross-flow filtration system does not require a pressure source, such as a pump, having a high-power output. Accordingly, smaller, lower power pressure sources can be used in the cross-flow filtration system of the invention, which means that the overall system does not occupy much space and has a small footprint. In some embodiments, only a single pump is required.

In certain embodiments, the pressure source may comprise a membrane pump. The membrane pump may be switched on to implement the active phase of the pulse cycle. The membrane pump may be switched off to implement the inactive phase of the pulse cycle.

The combination of the pulse cycles, a laminar flow with a Reynolds number smaller than 500, and an active phase longer than the inactive phase means that a high filtering throughput, efficient filtration and a longer duration of filtration can be obtained without breaks associated with the blockage of the filter membrane. These advantages can all be achieved with a cross-flow filtration system having a small footprint because a small pressure source, such as pump, can be used. This small footprint is also advantageous because the cross-flow filtration system can be included as part of a diagnostic apparatus or a laboratory analyser, where not much space is available.

Embodiments of the invention may use or comprise a hollow fiber filter membrane. A hollow fiber filter membrane may comprise a plurality of hollow fibers connected in parallel within an outer manifold. Each hollow fiber is configured as a tubular filter membrane having a tubular wall with inner surface and an outer surface. Each tubular filter membrane has an inner diameter, and this may define the characteristic linear dimension when calculating the Reynolds number of the flow through the hollow fiber filter membrane. The tubular wall is porous, with pores of a desired diameter. Wastewater is supplied to an inlet end of each hollow fiber and passes along the insides of the tubular filter membranes, across the inner surfaces. A filtrate component of the wastewater passes through the pores of the tubular wall, and can be collected at an outlet end of the manifold of the hollow fiber filter membrane. A remaining liquid fraction of the wastewater may continue to flow along the insides of the tubular filter membranes, together with particulate matter that does not pass through the pores, and can be output at an outlet end of the hollow fiber filter membrane separately from the filtrate. When the filter membrane comprises a plurality of hollow fibers, then the filter membrane may have a total number of hollow fibers of at least 10 fibers, for example at least 20 fibers, for example at least 50 fibers, preferably at least 75 fibers, such as at least 100 fibers. In some embodiments, the filter membrane may have a total number of hollow fibers of up to 2000 fibers, or up to 1000 fibers, or up to 750 fibers, or up to about 500 fibers. The total number of fibers will depend on the size of the filter membrane. In some embodiments, the filter membrane may comprise only one fiber or fewer than 10 fibers. Filter membranes with a small number of fibers, for example fewer than 10 fibers, may be configured as ceramic filters membranes.

It will be appreciated that in as wastewater flows through the inside of a tubular filter membrane, a filtrate fraction of the wastewater will pass through the pores in the tubular wall of the tubular filter membrane, and this will result in a decreasing velocity profile of the wastewater flow along the inside of the tubular filter membrane. In the context of the present application, the maximum Reynolds number of the flow is determined at a point in the tubular filter membrane where the flow velocity is at a maximum. This point may be at an inlet of the tubular filter membrane.

The cross-flow filtration system may be retrofitted to, or be a part of, a diagnostic apparatus or a laboratory analyser. For example, it can be incorporated as a module in a diagnostic apparatus or a laboratory analyser.

A third aspect of the invention provides a method of cross-flow filtering wastewater from a diagnostic apparatus or a laboratory analyser, wherein the wastewater comprises nanoparticles and/or microparticles, wherein the wastewater is streaming in a laminar flow across a surface of a filter membrane. The method comprises:
(A) applying a recovery phase in which there is nearly no wastewater flow and there is nearly no transmembrane pressure; and
(B) applying a cleaning phase in which the wastewater is streamed across the surface of the filter membrane with nearly no transmembrane pressure.

The recovery phase and the cleaning phase may be repeated several times.

The third aspect of the invention relates to a method for cleaning and/or recovering a filter membrane. The combination of a recovery phase and a cleaning phase can be used when the filter membrane shows signs of fouling, such as to restore the flow rate of permeate through the filter membrane.

The method of the third aspect of the invention can be used independently of the method of the first aspect. For example, conventional cross-flow filtration may be carried out until the filter membrane shows signs of becoming blocked. The method for cleaning and/or restoring the filter membrane in the third aspect of the invention may then be used to recover the filter membrane for further use.

The invention further relates to a computer program. The computer program comprises computer-executable code that when executed on a controller causes a cross-flow filtration system to perform a method according to the invention.

The invention also relates to a computer-readable medium. The computer-readable medium stores a computer program according to the invention.

Preferred, suitable, and optional features of any one particular aspect of the invention described below are also preferred, suitable, and optional features of any other aspect.

### BRIEF DESCRIPTION OF THE DRAWINGS

The invention is further described hereinafter with reference to the accompanying drawings.

FIGS. 1 to 3 are schematic illustrations of cross-flow filtration systems in accordance with the invention.

FIG. 4 is a graph showing the flow over time of a wastewater feed (f), the cleaned water permeate (p) and the wastewater retentate (r) in a conventional cross-flow filtration system.

FIG. 5 is a graph showing the permeate flow rate over time for a cross-flow filtration system operated with a conventional, continuous flow of wastewater feed (see “Pumping 60 min”) or when the wastewater feed is streamed in pulsed cycles (“Pulsed Protocol”) in accordance with the invention.

FIGS. 6 and 7 are graphs showing the permeate (p) flow rate during an active phase (A) or an inactive phase (I) of the pulse cycle. During the active phase (A), the transmembrane pressure is greater than 0 bar. The mean value of permeate flow (M) obtained when using pulse cycles is also shown, which is higher than the flow plateau (P) that is obtained without pulse cycles. The duration of the active phase in FIG. 6 is longer than in FIG. 7.

FIG. 8 is a graph showing the flow over time of a wastewater feed (f), retentate (r) and permeate (p) for a cross-flow filtration system where the wastewater feed is streamed in pulsed cycles in accordance with the invention.

FIG. 9 is a graph showing the pressure over time for the cross-flow filtration shown in FIG. 8. The graph shows the pressure of the wastewater feed (f), retentate (r), permeate (p) and the transmembrane pressure (t).

FIG. 10 is graph showing the effect of changing the duty cycle of the pulsatile laminar flow on the permeate flow rate.

FIGS. 11 and 12 are graphs showing the relationship between the flow rate, the Reynolds number and a parameter relating to the filter membrane, specifically the surface area (FIG. 11) or the number of fibers (FIG. 12) in the filter membrane.

### DEFINITIONS

The term “laminar flow” as used herein is the conventional meaning of this term in fluid dynamics. It is a type of liquid flow in which the liquid travels smoothly or in regular paths (in contrast to turbulent flow where the liquid undergoes irregular fluctuations and mixing). In this case, the liquid is wastewater from a diagnostic apparatus or a laboratory analyser. In a laminar flow, the velocity, pressure and other flow properties at each point in the liquid remain constant.

The term “streaming” as used herein means flowing, or conveying or passing a flow of, a liquid, in this case wastewater, across the surface of a filter membrane.

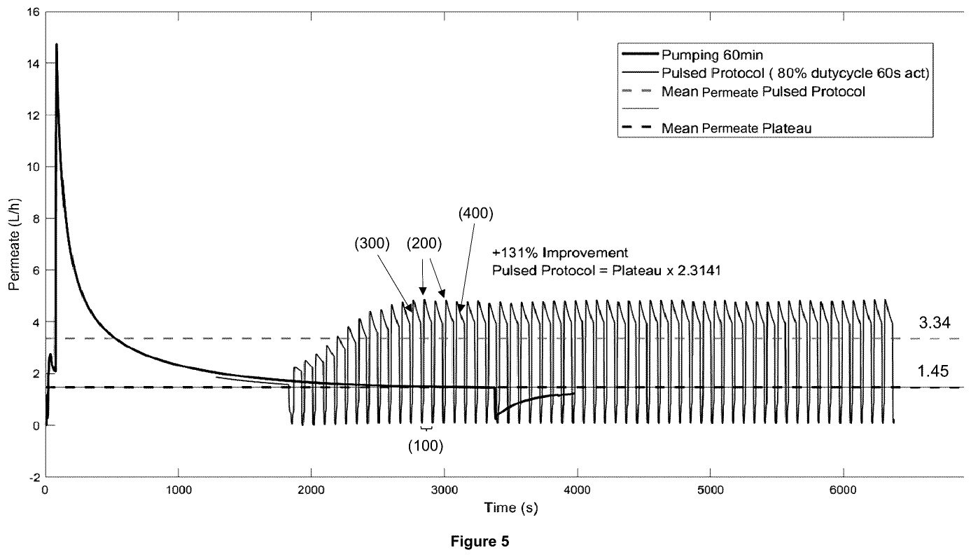

The term “pulse cycle” as used herein is used to define the way in which the wastewater is streamed across the surface of the filter membrane. The wastewater is streamed across the surface of the filter membrane with a pulsatile flow (also known as Womersley flow). A pulsatile flow, as used in fluid dynamics, is a flow (e.g. a flow of wastewater) with a periodic variation of the pressure. The pulsatile flow can be produced by streaming the liquid (e.g. wastewater) in pulses. The pulse cycle may be represented by a pulsatile wave (also known as a pulse wave or pulse train), such as shown in FIGS. 5 to 9.

The pulse cycle has a period. The period is the total duration of the pulse cycle. The period of the pulse cycle is related to the frequency of the pulse cycle by the following equation.

$${period}_{pulse cycle} = 1 / {frequency}_{pulse cycle} .$$

Each pulse cycle has an active phase and an inactive phase. The duration of the active phase is the active period. The duration of the inactive phase is the inactive period. The period of the pulse cycle is the sum of the active period and the inactive period.

In some instances, it may be helpful to refer to the duty cycle of the pulse cycle or the pulsatile flow. The term “duty cycle” as used herein refers to the ratio of the active period to the total period of a pulse cycle. The duty cycle (D) is defined as:

$$D = \frac{active period}{( active period + inactive period )} \times 100 .$$

The term “active phase” as used herein refers to a phase of the pulse cycle in which the wastewater is under a duty pressure.

The term “inactive phase” as used herein refers to a phase of the pulse cycle in which the wastewater is under an inactive pressure.

The term “duty pressure” as used herein relates to a pressure of wastewater on the retentate side of the filter membrane. The duty pressure is a pressure that is greater, preferably significantly larger, than the inactive pressure (defined below). The duty pressure is a pressure for achieving permeation of wastewater through the filter membrane, such as when the filter membrane is not obstructed or blocked as, for example, in conventional cross-flow filtration. In general, the duty pressure is greater than 0.0 bar, preferably greater than 0.1 bar.

The term “inactive pressure” refers to a pressure of wastewater on the retentate side of the filter membrane. Typically, the inactive pressure is a pressure at which there is no or nearly no (e.g. less than 1.0 L/hr) permeation of wastewater through the filter membrane, such as when the filter membrane is not obstructed or blocked as, for example, in conventional cross-flow filtration. In general, the inactive pressure may be greater than 0.0 bar or, preferably, the inactive pressure is about 0.0 bar, such as 0.0 to 0.2 bar.

The expression “significantly larger” as used herein refers to at least 10% larger, preferably at least 25% larger, more preferably at least 50% larger. This expression is used herein to describe the flow of feed in the active phase compared to the flow of feed in the inactive phase; and the flow throughput of permeate in the active phase compared to the flow throughput of permeate in the inactive phase.

The term “transmembrane pressure” or “TMP” as used herein refers is the pressure difference between the retentate side and the permeate side of the filter membrane.

$$TMP = pressure on the retentate side of the filter membrane - pressure on the permeate side of the filter membrane .$$

When the pressure on the permeate side is 0.0 bar, then the transmembrane pressure may be the same as the duty pressure during the active phase. Similarly, when the pressure on the permeate side is 0.0 bar, then the transmembrane pressure may be the same as the inactive pressure during the inactive phase, particularly when the filter membrane is not obstructed or blocked. The transmembrane pressure can be measured by conventional methods known in the art, such as by using flow or pressure sensors.

The term “feed” as used herein refers to the wastewater comprising nanoparticles and/or microparticles that is streamed across the surface of the filter membrane. The feed is streamed through an inlet of a filter module comprising the filter membrane.

The term “permeate” as used here refers to the cleaned wastewater that has passed through the filter membrane.

The term “retentate” as used herein refers to the wastewater that has been streamed across the surface of the filter membrane. The retentate is streamed through an outlet of a filter module comprising the filter membrane. From the outlet, the retentate may be streamed into a container (e.g. a liquid retentate storage container). In the container, the retentate may be mixed with wastewater, such as new wastewater from the diagnostic apparatus or the laboratory analyser, for recirculation. This wastewater may be streamed across the surface of the filter membrane in accordance with the method of the invention.

The term “filter cake” as used herein refers to any substance or material that is retained on or within the filter membrane. The substance or material is typically a solid that may block, or contribute to the blockage of, the filter membrane. The filter cake may be an aggregate of the nanoparticles and/or microparticles retained on or within the filter membrane.

The term “disposed” as used herein has it conventional meaning and includes the term “located”.

The term “diagnostic apparatus” as used herein includes any such device or apparatus for performing a diagnostic function, which produces a wastewater comprising nanoparticles and/or microparticles. Diagnostic apparatus are used to identify the nature or a cause of a certain phenomenon, particularly in the medical field where the information provided by the apparatus can help a clinician form a diagnosis about a patient's health. The diagnostic apparatus is preferably a medical diagnostic apparatus.

The term “laboratory analyser” as used herein includes any device or apparatus, typically an automated device or apparatus, for use in a laboratory to qualitatively identify the presence, or quantitatively determine an amount (e.g. typically a concentration), of a chemical or a substance in a sample, and which produces a wastewater comprising nanoparticles and/or microparticles. It is preferred that the laboratory analyser is a laboratory analyser for medical use (e.g. a medical laboratory analyser). The sample may, for example, be serum, plasma, urine or other bodily fluids from a human or animal patient. The substances for analysis or analytes using the device or apparatus may include proteins, metabolites, electrolytes or drugs. The laboratory analyser may use a heterogeneous immunoassay. Examples of laboratory analysers include the cobas™ e 801 modules and the cobas™ c 701 modules produced by the present applicant.

The term “wastewater” as used herein refers to an aqueous solution comprising nanoparticles and/or microparticles. The wastewater is a waste product directly obtained from a diagnostic apparatus or laboratory analyser. The nanoparticles and/or microparticles are used or unused reagents from the diagnostic or laboratory analysis performed by the diagnostic apparatus or the laboratory analyser. The wastewater may include other waste or by-products from the diagnostic or laboratory analysis, such as the chemical or substance for analysis.

The terms “nanoparticles” and “microparticles” as used herein generally refer to particles having a size less than or equal to 5 mm. The microparticles have a particle size of less than or equal to 5 mm (preferably less than or equal to 1 mm) and greater than or equal to 1.0 μm. The nanoparticles have a particle size of less than 1.0 μm (e.g. 999 nm or less) to greater than or equal to 1 nm. In general, the nanoparticles and/or microparticles are reagents used in the diagnostic apparatus or the laboratory analyser.

The term “Reynolds number” as used herein is the ratio of inertial forces to viscous forces within the wastewater flow that is subjected to relative internal movement due to different fluid velocities within the tubular filter membrane. The Reynolds number is defined as Re=ρuL/μ, where ρ is the density of the wastewater, u is the flow speed, L is the characteristic linear dimension (i.e. the inside diameter of the tubular filter membrane) and μ is the dynamic viscosity of the wastewater.

For the avoidance of doubt, all parameters relating to the flow of the wastewater or the throughput of the permeate relate to temperature of performing a method according to the invention or operating the system of the invention. In general, the invention is performed or operated at room temperature (e.g. 20° C.). Any numerical value for a pressure refers to the pressure above atmospheric pressure, unless the context indicates otherwise.

### DETAILED DESCRIPTION

Cross-flow filtration where a laminar flow of liquid is passed across a surface of the filter membrane often results in a reduction in, or stoppage of, filtration due to obstruction or blockage of the filter membrane. An irreversible topcoat may be formed on the surface of the filter membrane due to absorption, compaction or precipitation of contaminants. This topcoat prevents access to the pores within the filter membrane by covering the openings to these pores. The pores themselves may also become blocked, such as when a particle becomes lodged within a channel of the pore. It is also possible for the filter membrane to become clogged or blocked by substances with an affinity for the membrane material. These substances may enter a pore channel and become adsorbed to the channel wall. Biofouling of the filter membrane can also occur through, for example, the formation of an extracellular polymeric substance (EPS) biofilm produced by microorganisms.

During conventional use of a cross-flow filtration system, the duty pressure and/or transmembrane pressure pushes particles against the filter membrane. These particles may accumulate on the surface of the filter membrane or within the filter membrane to form a filter cake of the particles. This filter cake hinders the flow of liquid into or through the filter membrane and produces an exponential reduction in the filtration rate until it reaches a plateau. At this point, filtration reaches a steady state, with the filtration rate remaining stable at the plateau level. This is the asymptotic value of the steady mentioned below. When the filtration system reaches a steady state, then it is energetically less efficient because the same amount of energy is needed as during the initial stages of filtration, but less liquid is filtered.

Therefore, it is preferred that the active period is shorter than the time it takes for the flow throughput of permeate to drop from the maximum flow throughput of permeate in the active phase to a steady state flow throughput of permeate. The active period is preferably not more than 80% of the time needed to reach the steady state, particularly not more than 60%, more preferably not more than 50%, and even more preferably not more than 40% of the time needed to reach the steady state. The steady state is an asymptotic value which is practically never achieved. For the present invention, the time when the steady state is reached is when the flow throughput is in a range of 5% of the asymptotic value of the steady state.

This adjustment of the active phase with respect to the steady state can also be applied to other processes of cross-flow filtering a liquid by means of a pulsatile flow through a membrane, particularly through a hollow fiber membrane.

The invention is specifically concerned with the cross-flow filtration of a liquid, in this case a wastewater from a diagnostic apparatus or a laboratory analyser, where the liquid is passed or conveyed across the surface of a filter membrane with a laminar flow. Nanoparticles and/or microparticles are removed from the filter membrane by size exclusion. In other words, the pore size of the filter membrane should be sufficiently small to prevent the nanoparticles and/or microparticles from entering the pores.

In the first aspect of the invention, the method comprises streaming the wastewater across the surface of the filter membrane with a flow rate, so that the flow of the wastewater is a laminar flow with a Reynolds number (Re) of less than 500. It is preferred that the flow of the wastewater is a laminar flow with a Reynolds number (Re) of less than 250, more preferably less 150, and even more preferably the Reynolds number (Re) is no more than 100, particularly 75 or less. The Reynolds number is determined at the wastewater temperature at which cross-flow filtration is to be performed.

Typically, the flow of the wastewater is a laminar flow with a Reynolds number (Re) of from 1 to less than 500. It is preferred that the flow of the wastewater is a laminar flow with a Reynolds number (Re) of from 5 to 250, more preferably 10 to 150, and even more preferably the Reynolds number (Re) is from 15 to 100, particularly 20 to 75 or 10 to 75.

The invention avoids or reduces the blockage of the filter membrane during the cross-flow filtration of a liquid, in this case wastewater from a diagnostic apparatus or a laboratory analyser. When the filter membrane becomes obstructed, then the flow of permeate through the filter membrane decreases, thereby reducing the efficiency of the cross-flow filtration process. The invention improves the performance of a cross-flow filtration system. The wastewater is stream across the filter membrane in pulse cycles, which can disrupt the formation or aid the removal of filter cake on and/or within the filter membrane. By reducing or preventing the blockage of the filter membrane, cross-flow filtration can be performed for longer periods of time, while maintaining a high flow of permeate through the filter membrane. The invention reduces the need for regularly stopping filtration to unblock and clear the filter membrane. It may also prolong the lifetime of the filter membrane, as they are delicate and can easily be damaged.

In the method of the invention, wastewater is streamed in pulse cycles across the surface of the filter membrane. The or each pulse cycle has an active phase and an inactive phase. The advantages provided by the first aspect of the invention are associated with using this combination of an active phase and an inactive phase.

It is assumed that the nanoparticles and/or microparticles on or within the filter membrane are able to redisperse into the wastewater during the inactive phase. There is no or nearly no flow of wastewater over the surface of the filter membrane during the inactive phase, which allows the particles to redisperse into the wastewater. The pulse cycles may also create a localised disturbance over the surface of the filter membrane, which may also prevent the particles from settling on or within the filter membrane and/or breaks up any filter cake that is formed on or within the filter membrane.

The pulse cycle comprises an active phase. It is preferred that the pulse cycle comprises a single active phase.

The duration of the active phase is the active period. The active period may be at least 5 seconds, such as least 10 seconds, preferably at least 30 seconds, more preferably at least 60 seconds, and even more preferably at least 90 seconds, such as at least 100 seconds.

Typically, the active period is no more than 3600 seconds, such as no more than 2800 seconds, preferably no more than 1800 seconds, more preferably no more than 1200 seconds, even more preferably no more than 900 seconds, such as no more than 600 seconds.

It is preferable that the active period is from 5 to 3600 seconds, such as from 10 to 2800 seconds, preferably 30 to 1800 seconds, more preferably from 60 to 1200 seconds, such as from 90 to 900 seconds, and even more preferably from 100 to 600 seconds.

The or each active phase has a duration of greater than 50% of the corresponding pulse cycle. Thus, the active period is greater than 50% of the period of the pulse cycle.

The inventors have found that when the active phase is longer than the inactive phase, then greater throughput of permeate is obtained, while ensuring that the cross-flow filtration is energy efficient. For the avoidance of doubt, the inactive period cannot be zero for there to be a pulse cycle.

The duration of the active phase as a percentage of the total duration of the pulse cycle can be expressed by the parameter known as the duty cycle. When the active period is greater than 50% of the period of the pulse cycle, then this is equivalent to a duty cycle of greater than 50%.

The duty cycle may be greater than or equal to 51%, preferably greater than or equal to 55%, more preferably greater than or equal to 57%, such as greater than or equal to 60%, even more preferably greater than or equal to 65%, preferably greater than or equal to 70%, and most preferred is a duty cycle greater than or equal to 75%.

The duration of the active phase does not exceed 99% of the corresponding pulse cycles, preferably does not exceed 95%, more preferably does not exceed 90%, and even more preferably does not exceed 80%, of the corresponding pulse cycles. In other words, the duty cycle does not exceed 99%, and preferably does not exceed 95%. More preferably, the duty cycle is less than or equal to 85%, more preferably less than or equal to 83%, such as less than or equal to 82%, even more preferably less than or equal to 81%, and most preferred is a duty cycle that is less than or equal to 80%.

Any lower limit for the duty cycle may be combined with any upper limit of the duty cycle.

The duty cycle may be greater than 50% and does not exceed 99%, preferably greater than or equal to 51% and less than or equal to 95%, more preferably greater than or equal to 55% and less than or equal to 90%, particularly greater than or equal to 55% and less than or equal to 85%, such as greater than or equal to 57% and less than or equal to 83%, particularly greater than or equal to 57% and less than or equal to 82%, even more preferably greater than or equal to 60% and less than or equal to 81%, especially greater than or equal to 65% and less than or equal to 80%, still more preferably greater than or equal to 70% and less than or equal to 80%, and most preferred is a duty cycle (D) that is greater than or equal to 75% and less than or equal to 80%.

The optimum duty cycle to provide the highest throughput of permeate, while minimizing energy when operating the pump, will depend on several factors, including the type of filter membrane, the flow rate of wastewater and the nature of the microparticles and/or nanoparticles.

In the active phase, the feed (e.g. of wastewater) has a flow of no more than 0.50 m/s, preferably less than 0.35 m/s, more preferably less than 0.25 m/s.

The feed has, in general, a flow of at least 0.01 m/s, preferably at least 0.03 m/s, and more preferably at least 0.05 m/s, in the active phase.

Any lower limit for the flow of feed may be combined with any upper limit for the flow of the feed.

The feed may have a flow of from 0.01 to 0.50 m/s, preferably 0.03 to 0.35 m/s, and more preferably 0.05 m/s to 0.25 m/s, in the active phase.

Generally, the flow of feed in the active phase is from 1.0 to 100 L/h, preferably from 2.5 to 75 L/h, more preferably 5.0 to 50 L/h, even more preferably 10.0 to 25 L/h.

It is preferred that the flow of feed in the active phase is substantially larger than the flow of feed in the inactive phase.

Generally, the feed (e.g. of wastewater) has a flow that is at least the same or greater than the flow throughput of permeate.

Typically, in the active phase, there is a flow throughput of permeate of greater than 0.0 m/s, preferably greater than 0.5 m/s, more preferably greater than 1.0 m/s.

In the active phase, it is preferred that there is a flow throughput of permeate of greater than 1.0 L/h, preferably greater than 1.5 L/h, more preferably greater than 2.0 L/h.

The flow throughput of permeate in the active phase is, in general, substantially larger than the flow throughput of permeate in the inactive phase.

When streaming the wastewater in pulse cycles across the surface of the filter membrane, the flow of wastewater in the active phase is a laminar flow and has a Reynolds number as defined above. The active phase is when the wastewater is streamed across the surface of the filter membrane with a flow and at a duty pressure that are used in conventional cross-filtration without pulse cycles. For many cross-flow filtration systems, the flow that is produced by a pressure source (e.g. pump) and/or flow inhibitor will be a laminar flow. If a turbulent flow is produced, then the flow may be adjusted to a laminar flow by reducing the flow rate of the wastewater and/or by changing the filter membrane.

The wastewater is streamed across the surface of the filter membrane under a duty pressure during the active phase. The duty pressure is a pressure that is sufficient for bringing about filtration of the wastewater (e.g. permeation through the filter membrane) during normal, conventional use of a cross-flow filtration system.

The duty pressure may be at least 0.5 bar, preferably at least 1.0 bar, more preferably at least 1.5 bar, and even more preferably at least 2.0 bar.

The duty pressure typically does not exceed 25.0 bar, preferably does not exceed 20.0 bar, more preferably does not exceed 15.0 bar, and even more preferably does not exceed 10.0 bar.

Any lower limit for the duty pressure may be combined with any upper limit for the duty pressure.

Typically, the duty pressure is from 0.5 to 25.0 bar, preferably 1.0 to 20.0 bar, more preferably 1.5 to 15.0 bar, and even more preferably 2.0 to 10.0 bar.

The transmembrane pressure in the active phase may be at least 0.5 bar, preferably at least 1.5 bar, more preferably at least 1.8 bar, and even more preferably at least 2.0 bar.

The transmembrane pressure in the active phase is typically no more than 10.0 bar, preferably no more than 6.0 bar, more preferably no more than 4.0 bar, and even more preferably no more than 3.0 bar.

Any lower limit for the transmembrane pressure may be combined with any upper limit for the transmembrane pressure.

The transmembrane pressure (TMP) in the active phase may be 0.5 to 10.0 bar, preferably 1.5 to 6.0 bar, more preferably 1.8 to 4.0 bar, even more preferably 2.0 to 3.0 bar.

Generally, the duty pressure may be the transmembrane pressure. The duty pressure may be measured as the transmembrane pressure, such as when the pressure on the permeate side of the filter membrane is 0.0 bar.

The pulse cycle also comprises an inactive phase. During the inactive phase, the wastewater is under an inactive pressure. Thus, either no or minimal permeation of wastewater through the filter membrane will occur.

Typically, in the inactive phase, there is a flow throughput of permeate of less than or equal to 1.0 L/h, preferably less than or equal to 0.5 L/h, more preferably less than or equal to 0.2 L/h.

The flow throughput of permeate in the active phase is, in general, substantially larger than the flow throughput of permeate in the inactive phase.

The pulse cycle may be represented by a pulsatile wave. When the active phase switches to the inactive phase, then there is a substantial pressure drop as the pressure changes from the duty pressure to the inactive pressure. Similarly, there is a substantial pressure increase as the pressure changes from the inactive pressure to the duty pressure when the inactive phase switches to the inactive phase.

Typically, the pulsatile wave has a discontinuous gradient. For example, the pulsatile wave is a non-sinusoidal wave. The pulsatile wave may be an asymmetric wave. The discontinuous gradient may represent the transition between the active phase and the inactive phase.

The inactive pressure is no more than 10% of the duty pressure, preferably no more than 5% of the duty pressure, more preferably no more than 2% of the duty pressure. The inactive pressure can be greater than or equal to 0.0 bar.

In a first embodiment of the inactive phase, the inactive pressure is about 0.0 bar, such from 0.0 to 0.2 bar. It is preferred that the inactive pressure is 0.0 bar.

In this embodiment, the flow of feed in the inactive phase is less than 1.0 L/h, preferably less than 0.5 L/h, more preferably less than 0.2 L/h, and even more preferably about 0.0 L/h. Thus, there is nearly no wastewater flow in the first embodiment of the inactive phase. This allows any nanoparticles and/or microparticles resting on or within the filter membrane to redisperse into the wastewater (e.g. the feed).

In a second embodiment of the inactive phase, the inactive pressure is from 0.0 to 0.5 bar, such from 0.1 to 0.3 bar, more preferably about 0.1 bar.

In this embodiment, the flow of feed in the inactive phase is from 1.0 to 100 L/h, preferably from 2.5 to 75 L/h, more preferably 5.0 to 50 L/h, even more preferably 10.0 to 25 L/h.

In the second embodiment of the inactive phase, the feed (e.g. of wastewater) has a flow of no more than 0.50 m/s, preferably less than 0.35 m/s, more preferably less than 0.25 m/s.

In the second embodiment of the inactive phase, the feed may have a flow of at least 0.01 m/s, preferably at least 0.03 m/s, and more preferably at least 0.05 m/s, in the active phase.

In this embodiment, any lower limit for the flow of feed may be combined with any upper limit for the flow of the feed.

In the second embodiment of the inactive phase, the feed may have a flow of from 0.01 to 0.50 m/s, preferably 0.03 to 0.35 m/s, and more preferably 0.05 m/s to 0.25 m/s, in the active phase.

The second embodiment of the inactive phase is where there is a flow of feed across the surface of the filter membrane, but without the presence of any substantial pressure on the retentate side to bring about permeation of the wastewater. The flow of feed across the surface of the filter membrane may assist in reducing or preventing blockage by, for example, removal of the outer layer of any filter cake that has started to form on the surface.

Generally, the flow of feed in the inactive phase, including in the first and second embodiments of the inactive phase, is less than the flow of feed in the active phase. Typically, the flow of feed in the active phase is substantially larger than the flow of feed in the inactive phase.

The inactive pressure may, in general, be the transmembrane pressure. The inactive pressure may be measured as the transmembrane pressure, such as when the pressure on the permeate side of the filter membrane is 0.0 bar.

The pulse cycle may comprise, or consist of, an active phase and a single inactive phase, such as the inactive phase of the first embodiment or the inactive phase of the second embodiment.

Alternatively, the pulse cycle may comprise, or consist of, an active phase and two inactive phases, such as the inactive phase of the first embodiment (e.g. the first inactive phase) and the inactive phase of the second embodiment (e.g. the second inactive phase). It is preferred that the first inactive phase followed by the second inactive phase. Thus, the pulse cycle may comprise an active phase and an inactive phase, which comprises a first inactive phase followed by a second inactive phase.

The pulse cycle may comprise an active phase and an inactive phase, where the inactive phase comprises the first inactive phase, the second inactive phase and at least one repetition of the first inactive phase and the second inactive phase.

When the inactive phase comprises a first inactive phase and a second inactive phase, then the inactive period is the total duration of the inactive phase.

A general feature of the method is that the pulse cycles may have a frequency of from 0.0015 Hz to 0.0100 Hz, preferably from 0.0020 Hz to 0.0080 Hz, more preferably 0.0030 Hz to 0.0070 Hz, such as 0.0040 Hz to 0.0060 Hz.

In the invention, the pulse cycle is adjustable. The pulse cycle may be adjusted using the flow inhibitor and/or the pressure source, as described herein.

The frequency of the pulse cycles may be adjusted, for example, to optimise the flow throughput of permeate. Thus, the method of the invention may comprise adjusting a frequency of the pulse cycles to optimise flow throughput of permeate. The frequency of the pulse cycles may be increased or decreased, preferably increased. By changing the pulse cycles, the pressure changes between the active and inactive phases may become more or less frequent, which can alter the flow throughput of permeate. It is advantageous for the pulse cycle to be variable because the optimum duty cycle can be determined using a single system setup.

The active phase is adjustable. The duty pressure and/or the active period can be adjusted, for example, to optimise (i) the efficiency of the filtering with respect to flow throughput of permeate and/or (ii) energy consumption. Thus, the method of the invention may comprise adjusting the duration of the active phase (e.g. the active period) to optimise the efficiency of the filtering with respect to flow throughput of permeate and/or energy consumption.

The inactive phase is adjustable. The inactive pressure and/or the inactive period can be adjusted. The inactive period can be adjusted to, for example, recover and/or clean the filter membrane.

When adjusting the active period and/or the inactive period, it is preferred that the active phases have a duration that remains greater than 50% of the corresponding pulse cycles.

The method may comprise detecting a reduction in flow throughput of permeate from the filter membrane. The reduction may be the absence of flow throughput of permeate from the filter membrane.

When a reduction in flow throughput of permeate is detected, then the frequency of the pulse cycles, the active period and/or the inactive period may be adjusted.

The method may comprise:
detecting a reduction in flow throughput of permeate from the filter membrane; and
adjusting a frequency of the pulse cycles to optimise flow throughput of permeate, and/or adjusting the duration of the active phase to optimise the efficiency of the filtering with respect to flow throughput of permeate and/or energy consumption.

The above steps may be repeated. For example, the method may comprise:
detecting a first reduction in flow throughput of permeate from the filter membrane;
adjusting a first frequency of the pulse cycles to a second frequency of the pulse cycles to optimise flow throughput of permeate, and/or adjusting a first duration of the active phase (e.g. first active period) to a second duration of the active phase (e.g. second active period) to optimise the efficiency of the filtering with respect to flow throughput of permeate and/or energy consumption;
detecting a second reduction in flow throughput of permeate from the filter membrane; and
adjusting the second frequency of the pulse cycles to a third frequency of the pulse cycles optimise flow throughput of permeate, and/or adjusting a second duration of the active phase to a third duration of the active phase (e.g. third active period) to optimise the efficiency of the filtering with respect to flow throughput of permeate and/or energy consumption.

In the above method, the first frequency of the pulse cycles is different to the second frequency of the pulse cycles. The second frequency of the pulse cycles is different to the third frequency of the pulse cycles. It is preferred that the first frequency of the pulse cycles is different to the third frequency of the pulse cycles. Similarly, the first active period is different to the second active period. The second active period is different to the third active period. It is preferred that the first active period is different to the third active period.

The above method may be repeated until the pulse cycles or the active phase can no longer be used to prevent blockage of the filter membrane.

The method may further comprise:
(A) applying a recovery phase in which there is nearly no wastewater flow and there is nearly no transmembrane pressure; and
(B) applying a cleaning phase in which the wastewater is streamed across the surface of the filter membrane with nearly no transmembrane pressure.

Steps (A) and (B) may be repeated, for example, several times.

Some embodiments relate to a method of cross-flow filtering wastewater from a diagnostic apparatus or a laboratory analyser, wherein the wastewater comprises nanoparticles and/or microparticles, and where the wastewater is streaming in a laminar flow across a surface of a filter membrane. The method comprises:
(a) streaming the wastewater across the surface of the filter membrane with a flow rate, so that the flow of the wastewater is a laminar flow with a Reynolds number (Re) of smaller than 500;
(b) streaming the wastewater in pulse cycles across the surface of the filter membrane, wherein each pulse cycle comprises one active phase in which the wastewater is under a duty pressure and one inactive phase in which the wastewater is under an inactive pressure, wherein the inactive pressure is no more than 10% of the duty pressure and the active phases have a duration of greater than 50% of the corresponding pulse cycles;
(c) separating the nanoparticles and/or microparticles from the wastewater when the wastewater passes through the filter membrane; and optionally repeating steps (a) to (c); then
(d) applying a recovery phase in which there is nearly no wastewater flow and there is nearly no transmembrane pressure; and
(e) applying a cleaning phase in which the wastewater is streamed across the surface of the filter membrane with nearly no transmembrane pressure; and optionally repeating steps (d) and (e).

Steps (d) and (e) above are steps (A) and (B), respectively. After steps (d) and (e), then steps (a) to (c) may be repeated.

Alternatively, the method of applying a recovery phase (A) and a cleaning phase (B) can be used independently of the method of the first aspect. For example, conventional cross-flow filtration may be carried out until the filter membrane shows signs of becoming blocked. The method for cleaning and/or restoring the filter membrane in the third aspect of the invention may then be used to recover the filter membrane for further use.

Step (A) or (d) may include detecting a reduction in flow throughput of permeate from the filter membrane; and applying a recovery phase in which there is nearly no wastewater flow and there is nearly no transmembrane pressure.

The method may include a recovery phase. In the recovery phase, there is nearly no wastewater flow and there is nearly no transmembrane pressure. The wastewater is stationary over the filter membrane and there is no pressure differential to drive the wastewater through the filter membrane. Any nanoparticles and/or microparticles obstructing or blocking the filter membrane can redisperse into the wastewater over the surface of the filter membrane. This allows the filter membrane to be recovered.

In the recovery phase, there is nearly no transmembrane pressure (TMP).

Thus, the TMP is about 0.0 bar, such from 0.0 to 0.2 bar. It is preferred that the TMP is 0.0 bar.

There is nearly no wastewater flow in the recovery phase. Thus, the wastewater flow is less than 0.5 L/h, preferably less than 0.2 L/h, and more preferably about 0.0 L/h.

The recovery phase may have a duration of from 30 to 1800 seconds, more preferably from 60 to 1200 seconds, such as from 90 to 900 seconds, and even more preferably from 100 to 600 seconds.

The method may also include a cleaning phase. The cleaning phase includes streaming wastewater across the surface of the filter membrane with nearly no transmembrane pressure. There is no pressure differential to drive the wastewater through the filter membrane. There is also no flow resistance because, for example, the flow inhibitor is inactive. Streaming the wastewater over the filter membrane assists in reducing or preventing blockage by, for example, removal of the outer layer of any filter cake that has formed on the surface of the filter membrane.

In the cleaning phase, there is nearly no transmembrane pressure (TMP). Thus, the TMP is from 0.0 to 0.5 bar, such from 0.1 to 0.3 bar, more preferably 0.0 to 0.1 bar (e.g. about 0.1 bar).

In the cleaning phase, the wastewater is streamed across the surface of the filter membrane with a flow of from 1.0 to 100 L/h, preferably from 2.5 to 75 L/h, more preferably 5.0 to 50 L/h, even more preferably 10.0 to 25 L/h.

The flow of wastewater in the cleaning phase may be no more than 0.50 m/s, preferably less than 0.35 m/s, more preferably less than 0.25 m/s.

The flow of wastewater in the cleaning phase may be at least 0.01 m/s, preferably at least 0.03 m/s, and more preferably at least 0.05 m/s.

Any lower limit for the flow of wastewater may be combined with any upper limit for the flow of the wastewater.

The flow of wastewater in the cleaning phase may be from 0.01 to 0.50 m/s, preferably 0.03 to 0.35 m/s, and more preferably 0.05 m/s to 0.25 m/s.

The recovery phase and the cleaning phase may be repeated, for example, several times.

After the filter membrane has been recovered the method of the first aspect of the invention can then be performed.

The invention generally relates to the filtration of nanoparticles and/or microparticles in the wastewater from a diagnostic apparatus or a laboratory analyser.

The nanoparticles and/or microparticles are solid.

Typically, the nanoparticles and/or the microparticles are monodisperse. The nanoparticles and/or the microparticles are monodisperse when the range of particles sizes deviate from the mean particle size by 10% or less, preferably 8% or less, such as 5% or less, more preferably 3% or less, such as 2% or less, and even more preferably 1% or less.

In general, the nanoparticles have a particle size from 1 nm to 999 nm, preferably from 5 nm to 750 nm, more preferably from 10 nm to 500 nm, such as from 25 nm to 250 nm.

The microparticles have a particle size of from 1000 nm (e.g. 1.0 μm) to 5000 μm, preferably from 1.5 μm to 1000 μm, such as from 1.5 μm to 999 μm, more preferably from 2.0 μm to 500 μm, even more preferably 2.5 μm to 100 μm.

The nanoparticles and/or microparticles can, for example, have any composition. The nanoparticles and/or microparticles may each comprise a polymer (e.g. be plastic), an inorganic material, such as a magnetic material, or a biological material, such as a protein.

In principle, any tubular filter membrane may be used in the invention provided that it is suitable for removing the nanoparticles and/or microparticles from the wastewater by a particle size-based filtration technique.

A tubular filter membrane can have a diameter of not more than 5 mm and particularly not more than 2 mm or not more than 1 mm. A tubular filter membrane comprises usually a diameter of at least 0.2 mm particularly at least 0.5 mm or at least 1 mm. There are known small tubular filter membranes having a diameter of even less than 0.2 mm, such as 175 μm or large tubular filter membranes having a diameter of more than 2 mm or more than 5 mm. The large tubular filter membranes are usually ceramic tubular filter membranes.

The filter membrane is, in general, porous.

The filter membrane may be a hollow fiber membrane (e.g. a tubular membrane filter (TMF)).

The filter membrane may comprise, or consist essentially of, a polymer, a ceramic material or a cellulose-containing filter (e.g. a paper filter). It is preferred that the filter membrane comprises, or consists essentially of, a polymer or a ceramic material.

The polymer may be selected from a polyvinylidene fluoride, a polysulfone, a polyacrylonitrile and a poly(acrylonitrile)-poly(vinyl chloride) copolymer. When the filter membrane comprises, or consists essentially of, a polymer, it is preferred that the polymer is a polysulfone. More preferably, the polysulfone is a polyethersulfone (PES).

The ceramic material may comprise a material selected from Al₂O₃, TiO₂, ZrO₂, ZnO, SiO₂ and a composite material comprising two or more thereof (e.g. TiO₂—SiO₂, TiO₂—ZrO₂).

The cellulose-containing filter may comprise cellulose acetate fibers.

The filter membrane has a pore size of at least 0.5 nm, preferably at least 1.0 nm, such as at least 5.0 nm, more preferably at least 50 nm, such as at least 100 nm. The pore size of the filter membrane should be selected to be smaller than the particle size of the nanoparticles and/or microparticles in the wastewater.

The filter membrane typically has a pore size of not more than 25 μm, preferably not more than 10 μm, such as not more than 5 μm, more preferably not more than 1 μm, and even more preferably not more than 0.5 μm.

Any lower limit for the pore size may be combined with any upper limit for the pore size. The pore size can be measured using conventional techniques, such as evapoporometry.

According to the present understanding of the inventors, it may be advantageous for the minimum average pore size to be somewhat smaller than the average diameter of the smallest nanoparticles or microparticles that are to be separated from the wastewater by the tubular filter membrane. For example, the minimum average pore size may be no more than 95%, or no more than 90%, or no more than 75%, or no more than 50% of the average diameter of the smallest nanoparticles or microparticles that are to be separated from the wastewater by the tubular filter membrane. Because of manufacturing tolerances, the pore sizes of the tubular filter membrane will tend to have a normal distribution about a specified pore size. Accordingly, if the specified pore size is too close to the average diameter of the smallest nanoparticles or microparticles, there is a likelihood that at least some pores will be large enough to allow the smallest nanoparticles or microparticles to enter the largest diameter pores and to become lodged in the pores. It may be difficult to clear the lodged nanoparticles or microparticles from the pores using only the gentle active phase flow of the pulse cycle without any reverse flow across the filter membrane.

Generally, the filter membrane has a pore size of from 0.5 nm to 25 μm, preferably from 1.0 nm to 10 μm, such as 5.0 nm to 5 μm, more preferably 50 nm to 1 μm, and even more preferably 100 nm to 0.5 μm. The filtration method is based on size-exclusion. Thus, the pore size of the filter membrane should be selected to be smaller than the particle size of the nanoparticles and/or microparticles in the wastewater.

The filter membrane typically has a nominal molecular weight limit of from 0.05 kDa to 500 kDa, preferably from 0.10 kDa to 250 kDa, more preferably from 0.15 kDa to 200 kDa.

Typically, the filter membrane has a surface area of from 0.010 m⁻² to 10.00 m⁻², preferably from 0.025 m⁻² to 5.00 m⁻², such as from 0.050 m⁻² to 1.00 m⁻².

The filter membrane may comprise a plurality of hollow fibers connected in parallel. When the filter membrane comprises a plurality of hollow fibers, then the filter membrane may have a total number of hollow fibers of at least 50 fibers, preferably at least 75 fibers, such as at least 100 fibers. The total number of fibers will depend on the size of the filter membrane.

The invention also provides a cross-flow filtration system. The system may be used to perform the method according to the invention.

The cross-flow filtration system comprises a filter module. The filter module comprises a filter membrane as described herein.

The filter module has an inlet for the feed and an outlet (e.g. first outlet) for the retentate. The inlet and the outlet are each disposed on the feed/retentate side of the filter membrane.

The inlet of the filter module is typically fluidly connected to a pressure source, preferably to an outlet for the feed of the pressure source.

The outlet for the retentate of the filter module is preferably fluidly connected to the flow inhibitor.

The pressure source is for streaming or driving the wastewater across the surface of the filter membrane. The pressure source may, for example, be (i) a pump or (ii) a pressure reservoir and a valve for controlled releasing the pressurised wastewater. The pressure reservoir may comprise a pressurized gas cushion for keeping the wastewater under pressure.

The cross-flow filtration methods and system of the invention use a pressure source to drive the feed (e.g. wastewater) across a surface of the filter membrane for filtration. The laminar flow of liquid feed is produced by means of the pressure source. Thus, the pressure source may control the flow of the feed. The pressure source may also produce the pulse cycles. Since the pressure source is not operated continuously, it uses less energy, thereby improving the energy efficiency of the method and system. When this improved energy efficiency is combined with the improvements obtained in filtration efficiency, the end result is the provision of methods and a system that provides a vast improvement in the overall efficiency of cross-flow filtration.

It is preferred that the pressure source is a pump. The pump is for driving feed across a surface of the filter membrane. The pump drives the feed to the filter membrane for it to be streamed across its surface.

The flow of the feed (e.g. wastewater) can be controlled by the pump. As the flow of wastewater passed over the filter membrane is relatively low, the cross-flow filtration system does not require a pump having a high-power output. Smaller, lower power pumps can be used in the cross-flow filtration system of the invention, which means that the overall system does not occupy much space.

The cross-flow filtration system of the invention may be suitable for incorporation as a module in a diagnostic apparatus or a laboratory analyser.

The pump may produce the pulse cycles by being sequentially switched on and off to produce the pulse cycles. Since the pump is not operated continuously, it uses less energy, thereby improving the energy efficiency of the method and system. When this improved energy efficiency is combined with the improvements obtained in filtration efficiency, the end result is the provision of a method and a system that provides a vast improvement in the overall efficiency of cross-flow filtration.

Typically, the system comprises a single pump.

The pump has an inlet for the feed (e.g. wastewater) and an outlet for the feed.

In general, the pump is a membrane pump or a centrifugal pump. It is preferred that the pump is a membrane pump.

Typically, the pump, particularly the membrane pump, is a positive displacement pump.

The flow inhibitor is for providing a flow resistance during the active phases of the pulse cycles.

The flow inhibitor is disposed downstream of the filter module on a retentate side of the filter module. An inlet of the flow inhibitor is typically fluidly connected to the outlet for the retentate of the filter module.

The flow inhibitor may have an inlet and an outlet.

The outlet of the flow inhibitor may be fluidly connected to a liquid retentate storage container. The liquid retentate storage container may be the container providing the source of the feed. The liquid retentate may be recycled and included as part of the feed.

The flow inhibitor may be a pressure limiter, a flow resistance means having a switchable bypass (e.g. under the control of the controller) or a controllable valve (e.g. under the control of the controller).

The flow inhibitor may be used to control the transmembrane pressure by controlling the pressure of the feed on the feed/retentate side of the filter membrane.

The pressure source, such as the pump, may work against the flow inhibitor, which creates a variable flow resistance. Since the flow inhibitor aims to keep the pressure constant on its output side, it may create a high flow resistance when there is a high pressure on the input side of the flow inhibitor limiter and a low flow resistance when there is a low pressure on the input side. During an active phase of a pulse cycle, the flow inhibitor opposes the pressure generated by the pressure source with a high flow resistance, resulting in a rapid pressure increase and a large TMP. During an inactive phase of the pulse cycle, the flow resistance decreases because the pressure drops on the input side of the flow inhibitor, which accelerates the pressure drop and thus the TMP quickly becomes small or can even drop towards 0. Providing the flow inhibitor pressure limiter at the output of the filter module on the retentate side thus leads to an amplification of the pulses, whereby the steepness of the edges is increased considerably.

It is preferred that the flow inhibitor is a pressure limiter. The pressure limiter is a device which controls the pressure on its output side on a certain level as long as the pressure is on the input side above the certain level.

The pressure limiter is for regulating the pressure or flow rate of the feed. Particularly, the pump works against the pressure limiter, which forms a variable flow resistance. Since the pressure limiter is configured to keep the output pressure constant on its output side, it creates a high flow resistance when there is a high input pressure on the input side of the pressure limiter and a low flow resistance when there is a low input pressure.

Typically, the pressure limiter comprises a valve. The value may be controlled in dependence on the input pressure of the pressure limiter. The larger the input pressure, the more the valve will be closed. Conversely, the smaller the input pressure, the more the valve will be opened. Such types of pressure limiters are well known in the art.

Since the pump is operated in pulses, during an active phase of a pulse cycle, the pressure limiter opposes the pressure generated by the pump with a high flow resistance (e.g. by nearly closing the valve), resulting in a rapid pressure increase and a large TMP. During an inactive phase of the pulse cycle, the flow resistance decreases (e.g. by opening of the valve) because the input pressure drops, which accelerates the pressure drop and thus the TMP quickly becomes small or can even drop towards 0. Providing the pressure limiter at the output of the filter module on the retentate side thus leads to an amplification of the pulses, whereby the steepness of the edges is increased considerably.

For example, as can be seen in FIG. 5, the near closure of the valve of the pressure limiter leads to an overshoot of the pressure and thus to a flow peak 200 at the beginning of each active pulse 100. FIG. 5 shows the flow rate of the permeate. Since the flow rate of the permeate is approximately proportional to the TMP, the path of the flow rate also corresponds to the path of the pressure on the retentate side in the filter module.

The pressure value and thus also the TMP or the flow rate drop exponentially to the pressure value provided by the pump after overshooting. When the pump is switched off, the pressure value and thus also the flow rate drops abruptly (see falling edge 400 in FIG. 5).

The provision of the flow inhibitor, particularly a pressure limiter, leads to pulses 100 with steep rising edges 300 and steep falling edges 400. This may create pressure shocks that counteract the formation of filter cakes. It is assumed that the steep rising flanks 300 are particularly relevant for this. The effect associated with these steep edges may work in combination with the inactive phase to ensure that the filter membrane remains clear.

In principle, one would like to avoid such pressure shocks in hydraulic systems, as they can lead to damage to the system in the long run. Since the pump 10, the filter module 20 and the pressure limiter 30 are arranged close to each other in the present system, the moving mass is low, so that there is no significant risk of damage. In addition, the filter membrane 25 is usually not rigid, which leads to a damping of the pressure peaks or pressure shocks so that they are not reflected in the system and can affect other components. On the contrary, in the present system the small pressure shocks are desirable because they keep the filter membrane clean longer.

The pressure limiter may be a valve for controlling the pressure of the feed and/or the retentate.

The pressure limiter may include a pressure sensor. The pressure sensor may be connected, preferably electrically connected, to the valve.

The pressure limiter is typically disposed downstream of the outlet (e.g. for the retentate) to the filter module.

The pressure limiter may have an inlet and an outlet.

The inlet of the pressure limiter may be fluidly connected to the outlet (e.g. for the retentate) of the filter module.

The outlet of the pressure limiter may be fluidly connected to a liquid retentate storage container. The liquid retentate storage container may be the container providing the source of the liquid feed. The liquid retentate may be recycled and included as part of the liquid feed.

The cross-flow filtration system of the invention further comprises a controller. The controller is configured for carrying out a method according to the invention.

Typically, the controller is connected, preferably electrically connected, to the pressure source, such as the pump.

It is preferred that the controller is an electronic microcontroller.

The controller is configured to produce a stream of the wastewater in pulse cycles, preferably where the active phases have a duration of greater than 50% of the corresponding pulse cycles, as described above.

Typically, the controller is configured to produce the pulse cycles by sequentially switching the pressure source, particularly the pump, on and off to change the flow of the feed.

In general, the pulse cycles are typically produced by the pressure source, such as the pump, optionally in combination with the flow inhibitor (e.g. pressure limiter).

The pressure source and optionally the flow inhibitor may be used to control the length of the active period and the length of the inactive period.

The pressure source and optionally the flow inhibitor may be used to control the magnitude of the duty pressure.

The controller may be connected, preferably electrically connected, to the flow inhibitor, such as the pressure limiter or the pressure sensor of the pressure limiter. It is preferred that the controller is configured to produce pulse cycles by (a) sequentially switching the pressure source, such as the pump, on and off and (b) adjusting the flow inhibitor, to change the flow of the feed (e.g. wastewater).

The controller may be used to adjust the pulse cycles to increase a flow throughput of the permeate in the method of the invention.

The controller may be configured to produce the recovery phase and/or the cleaning phase, as described herein.

In the recovery phase, the controller may switch off the pressure source, such as the pump, to stop the streaming of the wastewater across the surface of the filter membrane. The controller may also set the flow inhibitor (e.g. close the pressure limiter) to stop flow of the retentate from the filter module. This means that the wastewater will be held over the surface of the filter membrane.

In the cleaning phase, the controller causes the wastewater to be streamed across the surface of the filter membrane without pulse cycles.

In general, the cross-flow filtration system may further comprise a sensor for detecting a flow rate of the wastewater. The sensor may be connected, preferably electrically connected, to the controller.

The sensor for detecting a flow rate of the wastewater may be a pressure sensor or a flow sensor. The pressure of the feed (e.g. wastewater) is related to the flow of the feed. Thus, by measuring the pressure of the feed, it is possible to determine the flow rate of the wastewater. It is preferred that the sensor is a pressure sensor.

The sensor is typically disposed upstream of the inlet to the filter module. Preferably, the sensor is fluidly connected to the inlet of the filter module. More preferably, the sensor is fluidly connected to the inlet of the filter module and the sensor is fluidly connected to the outlet of the pressure source, such as the pump.

The cross-flow filtration system may further comprise a sensor for measuring or detecting a flow rate or throughput of permeate. The sensor may be disposed at a permeate side of the filter membrane.

The filter module may further comprise an outlet for the permeate (e.g. a second outlet). The outlet is disposed on the permeate side of the filter membrane.

The outlet may be fluidly connected to the sensor for measuring or detecting the flow rate of permeate.

Typically, the sensor for measuring or detecting the flow rate or throughput of permeate is connected, preferably electrically connected, to the controller.

The sensor for measuring or detecting the flow rate or throughput of permeate may be used to detect a reduction in flow throughput of permeate from the filter membrane in the methods of the invention.

The controller may detect a reduction in flow throughput of permeate from the filter membrane using the sensor for measuring or detecting the flow rate or throughput of permeate. The controller may then adjust the pulse cycles, such as by:
sequentially switching the pressure source, particularly the pump on and off, and/or
adjusting the flow inhibitor, such as the pressure limiter, preferably the valve of the pressure limiter,
   to change the flow of the feed (e.g. wastewater), using feedback from at least one of the sensor for detecting a flow rate of the wastewater and the sensor for measuring or detecting the flow rate or throughput of permeate.

The inlet for the pressure source, such as the pump, may be fluidly connected to a source of the wastewater (e.g. feed). The source of the wastewater may be a container, such as the liquid retentate storage container, or a waste outlet from a diagnostic apparatus or a laboratory analyser. The source may include the wastewater comprising nanoparticles and/or microparticles.

The cross-flow filtration system may further comprise a pre-filter.

The pre-filter may be disposed between the outlet of the pressure source, such as a pump, and an inlet to the filter module. The inlet of the pre-filter may be fluidly connected to the outlet of the pressure source, such as a pump, and the outlet of the pre-filter may be fluidly connected to the inlet of the filter module. More preferably, the inlet of the pre-filter may be fluidly connected to the outlet of the pressure source, such as a pump, and the outlet of the pre-filter may be fluidly connected to the inlet of the sensor for detecting a flow rate of the wastewater.

Additionally or alternatively, the pre-filter may be disposed upstream of the inlet to the pressure source, such as the pump. An outlet of the pre-filter may be fluidly connected to the inlet of the pressure source, such as a pump. An inlet of the pre-filter may be fluidly connected to the source of the wastewater. When the source of the wastewater is a container, then the pre-filter may be disposed within the container.

The container may comprise an overflow sensor for detecting an overflow of the wastewater. The overflow sensor may be connected, preferably electrically connected, to the controller. When the overflow sensor detects an overflow of the wastewater in the container, then the controller may trigger an alarm.

The container may comprise a sensor for detecting a maximum volume of the wastewater. The sensor for detecting a maximum volume of the wastewater may be connected, preferably electrically connected, to the controller. When the sensor detects a maximum volume of the wastewater has been reached in the container, then the controller may trigger a notification or it may prevent further refilling of the container with the wastewater, such as by closing an opening or an inlet to the container.

The container may comprise a sensor for detecting a minimum volume of the wastewater. The sensor for detecting a minimum volume of the wastewater may be connected, preferably electrically connected, to the controller. When the sensor detects a minimum volume of the wastewater has been reached in the container, then the controller may stop the wastewater from the container by switching off the pressure source, such as a pump.

In general, the cross-flow filtration system may further comprise a bypass valve. The bypass value has an inlet and an outlet.

The bypass valve may be connected, preferably electrically connected, to the controller.

The inlet of the bypass valve is fluidly connected between an outlet of the pressure source and an inlet of the filter module. The bypass valve may be fluidly connected between an outlet of the pressure source and an inlet of the sensor for detecting a flow rate of the wastewater, when the sensor is disposed upstream of the inlet to the filter module. Alternatively, the bypass valve may be fluidly connected between an outlet of the sensor for detecting a flow rate of the wastewater an inlet of the filter module. The bypass valve allows the wastewater to bypass the filter module in the event of a malfunction.

The outlet of the bypass valve may be fluidly connected to the source of the wastewater, such as through a conduit connector.

Typically, the cross-flow filtration system may comprise a flow switch. The flow switch has an inlet, a first outlet and a second outlet.

The flow switch may be disposed downstream of the outlet of the filter module. Thus an inlet of the flow switch may be fluidly connected to the outlet of the filter module.

The flow switch is typically disposed upstream of the flow inhibitor. A first outlet of the flow switch may be fluidly connected to an inlet of the flow inhibitor.

The flow switch is typically disposed upstream of the source of the wastewater. The second outlet of the flow switch may be fluidly connected to the source of the wastewater, such as through a conduit connector. For the avoidance of doubt, there is no flow inhibitor disposed between the second outlet of the flow switch and the source of the wastewater.

The flow switch may be connected, preferably electrically connected, to the controller. The controller may be configured to control the flow switch, particularly the flow of retentate from the filter module into either the flow inhibitor or the source of the wastewater.

The flow switch is used to control the flow of retentate from the filter module. In a first position, the flow switch directs the flow of retentate from the filter module into the flow inhibitor (e.g. through the first outlet of the flow switch). In a second position, the flow switch directs the flow of retentate from the filter module into the source of the wastewater, such as through a conduit connector.

The flow switch may be used in the method of the invention.

In the cleaning phase, the flow switch may be switched to the second position. This is to direct the flow of retentate from the filter module into the source of the wastewater, such as through a conduit connector. The wastewater is then streamed across the surface of the filter membrane without pulse cycles and without the flow of wastewater being inhibited. This streaming of the wastewater over the filter membrane assists in reducing or preventing blockage by, for example, removal of the outer layer of any filter cake that has formed on the surface of the filter membrane.

When applying the cleaning phase, the controller may be configured to switch the flow switch from the first position to the second position.

When applying the recovery phase, such as after a cleaning phase, the controller may be configured to switch the flow switch from the second position to the first position.

The cross-flow filtration system may further comprise a conduit connector. The conduit connector has an outlet fluidly connected to the source of the wastewater.

The conduit connector may have an inlet (e.g. a first inlet) fluidly connected to an outlet of the bypass valve.

The conduit connector may have an inlet (e.g. a second inlet) fluidly connected to an outlet of the flow inhibitor.

The conduit connector may have an inlet (e.g. a third inlet) fluidly connected to the second outlet of the flow switch.

The invention further relates to a computer program. The computer program comprises computer-executable code that when executed on a controller (e.g. a computer system) causes a cross-flow filtration system to perform the method of the invention.

The invention also relates to a computer-readable medium. The computer-readable medium stores the computer program.

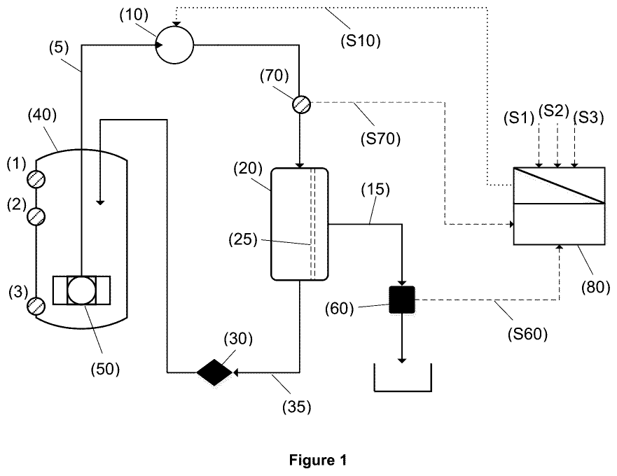

FIG. 1 shows an embodiment of a cross-flow filtration system of the invention. The pressure source is pump 10. Pump 10 draws wastewater (e.g. feed) through conduit 5 from container 40 through pre-filter 50. The operation of pump 10 is controlled by electronic microcontroller 80 via electrical coupling S10. The flow rate of the wastewater passing into filter module 20 is measured using pressure sensor 70, which is electrically couped S70 to the electronic microcontroller 80. Wastewater from pump 10 is passed or conveyed into filter module 20 having a filter membrane 25.

If the filter membrane is not obstructed, then permeate is produced that passes into conduit 15. The flow rate of permeate in conduit 15 is measured using flow sensor 60. Flow sensor 60 is electrically connected S60 to the electronic microcontroller 80 and provides information about the amount of permeate produced during filtration. The permeate passes through flow sensor 60 and may be collected in container.

Any wastewater from the feed that does not pass through the filter membrane 25 is retentate. The retentate leaves filter module 20 in conduit 35 and into a flow inhibitor, which in this case is pressure limiter 30. Pressure limiter 30 is used to control the pressure of feed/retentate on the feed/retentate side of the filter membrane 25. From the pressure limiter 30, the retentate is returned to container 40 to be recycled as part of the liquid feed.

Signals are sent via electrical coupling S10 to pump 10 to sequentially switch the pump on and off to produce pulse cycles. The switching of the pump on and off controls the length of the active period and the inactive period of the pulse cycles. The magnitude of the duty pressure is determined in part by the flow output from pump 10.

The pressure within the system is monitored using pressure sensor 70 and is adjusted using pressure limiter 30. Pressure limiter 30 may also be used to adjust the active period and magnitude of the pulse cycle. The active period or the duty cycle of the pulse cycle may be varied until flow sensor 60 detects permeate having a flow rate meeting a certain minimum threshold value. At this point, the parameters relating to the pulse cycle may be fixed and cross-flow filtration is performed. If flow sensor 60 detects a reduction in the flow rate of permeate below the certain minimum threshold value, then the pulse cycle may be adjusted until the flow rate of permeate crosses the threshold value again.

Container 40 has a sensor 1 for detecting an overflow of wastewater from the container. Sensor 1 is electrically connected S1 to the electronic microcontroller 80. When sensor 1 detects an overflow, then the electronic microcontroller 80 may trigger an alarm.

Container 40 has a sensor 2 for detecting a maximum volume of wastewater in the container. Sensor 2 is electrically connected S2 to the electronic microcontroller 80. When sensor 2 detects that the volume of wastewater has reached the maximum level, then the electronic microcontroller 80 may trigger a notification. The notification may ask the end user if the cross-filtration process should be started.

Container 40 has a sensor 3 for detecting a minimum volume of wastewater in the container. Sensor 3 is electrically connected S3 to the electronic microcontroller 80. When sensor 3 detects that the minimum volume of wastewater has been reached, then the electronic microcontroller 80 may trigger an alarm and/or the pump 10 may be switched off.

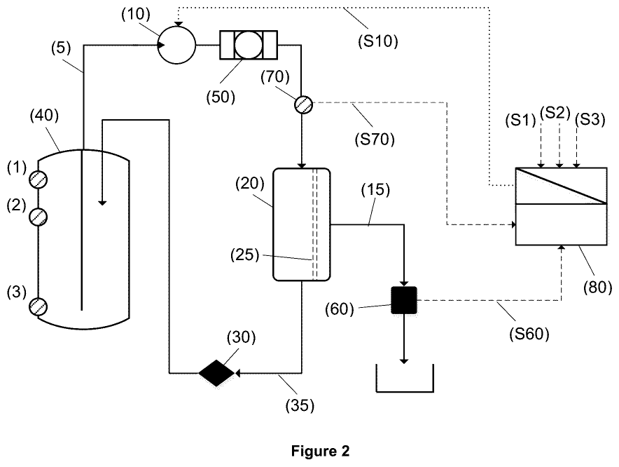

FIG. 2 shows an alternative embodiment of a cross-flow filtration system of the invention. The system is identical to the system shown in FIG. 1 except that pre-filter 50 is located between pump 10 and pressure sensor 70, instead of in the container 40.

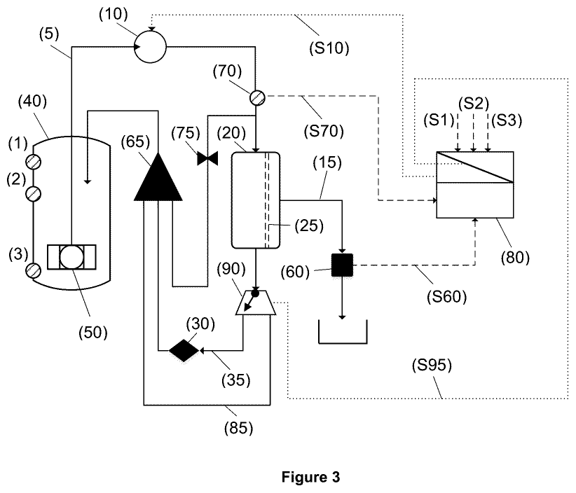

FIG. 3 shows a further embodiment of a cross-flow filtration system of the invention. This embodiment may be used to perform the method of the invention.

The embodiment shown in FIG. 3 can be used to perform the method of the invention in the same way as the embodiments shown in FIGS. 1 and 2.

The cross-flow filtration system in FIG. 3 includes bypass valve 75, which is connected between sensor 70 and filter module 20. In the event of a problem, bypass valve 75 can be opened or switched on to direct the flow of wastewater away from filter module 20. The wastewater is directed into container 40 through conduit connector 65. The bypass valve is included to protect the filter module from damage.

The outlets from bypass valve 75, pressure limiter 30 and the second outlet of flow switch 90 can be connected into a single conduit by conduit connector 65. The single conduit from conduit connector 65 directs the flow into container 40.

The cross-flow filtration system also includes flow switch 90 connected to the outlet of filter module 20. Flow switch 90 directs the flow of retentate through pressure limiter 30 via conduit 35 or through conduit 85 into container 40 via conduit connector 65.

In a first position, the flow switch 90 connects the outlet of filter module 20 to the pressure limiter 30.

In this first position of flow switch 90, the first embodiment of the inactive phase (e.g. the first inactive phase) can be performed in the method of the invention. By closing pressure limiter 30 and switching off pump 10, the wastewater is under an inactive pressure and the flow of wastewater is zero or nearly zero.

The second embodiment of the inactive phase (e.g. the second inactive phase) can also be performed in the method of the invention when flow switch 90 is in the first position to connect the outlet of the filter module 20 to the pressure limiter 30 (e.g. as in FIGS. 1 and 2). The pressure limiter 30 can be fully opened to allow the retentate to flow through it without resistance, thereby ensuring that the wastewater is under an inactive pressure.

When flow switch 90 is in the first position, then the recovery phase can be performed. As above, by closing pressure limiter 30 and switching off pump 10, the wastewater is under an inactive pressure and the flow of wastewater is zero or nearly zero.

In a second position, the flow switch 90 connects the outlet of filter module 20 to conduit 85, which bypasses pressure limiter 30.

In this second position of flow switch 90, the second embodiment of the inactive phase (e.g. the second inactive phase) can be performed in the method of the invention. When the pressure limiter 30 is bypassed, pump 10 continues to operate without producing pump cycles and the retentate flows from the filter module 20 without resistance, thereby ensuring that the wastewater is under an inactive pressure.

When flow switch 90 is in the second position, then the cleaning phase can be performed. Pump 10 operates to produce a stream of the wastewater without pulse cycles. The pressure limiter 30 is bypassed and the retentate flows from the filter module 20 without resistance, thereby ensuring that there is no or nearly no transmembrane pressure.

Flow switch 90 has an electrical connection S95 to the electronic microcontroller 80.

In response to a signal from flow sensor 60 indicating either the absence of, or a decrease in, the flow throughput of permeate, the electronic microcontroller 80 may apply a recovery phase to the filter membrane 25. The electronic microcontroller 80 may send a signal via connection S10 to switch off pump 10 and a signal to pressure limiter 30 to stop flow of retentate through the pressure limiter 30. The wastewater remains stationary over the filter membrane 25 to redisperse any particles that have become deposited on the filter membrane.

After a predetermined amount of time, the electronic microcontroller 80 may apply a cleaning phase to the filter membrane 25. The electronic microcontroller 80 may send a signal via connection S10 to switch on pump 10 without producing pulse cycles to stream the wastewater through filter module 20. At about the same time, the electronic microcontroller 80 may send a signal to flow switch 90 to switch to the second position. This connects the outlet of filter module 20 to conduit 85, thereby bypassing pressure limiter 30. The wastewater passing through the filter module 20 may clean filter membrane 25. The wastewater is returned to container 40 to stop flow of retentate through the pressure limiter 30, such as through conduit connector 65.

The concentration of nanoparticles and/or microparticles in container 40 may increase over time after performing the recovery and cleaning phases. When sensor 3 detects a minimum level of wastewater, then the nanoparticles and/or microparticles collected in container 40 may be removed and disposed of.

As an alternative to using pump 10 to produce the pulse cycles in the method of the invention, flow switch 90 may be rapidly switched between the first position and the second position to produce the pulse cycles.

### EXAMPLES

The following examples are provided to illustrate the invention and are not intended to limit the scope of the invention, as described herein.

### Comparative Example

Cross-flow filtration was simulated using a system comprising a membrane pump, a filter membrane, a pressure limiter and a tank with sensors. The filter membrane was a 150 kDa (pore size 4.54 nm) polyethersulfone (PES) membrane (NX-Filtration™). A high accuracy testing device (Convergence Industry™ B.V.) was used to measure the flow rates and pressures within the system.

The system was operated using a conventional, continuous laminar flow of a liquid feed, which contained microplastic (3 L of liquid containing plastic particles having a particle size of 110 to 120 nm at a concentration of 0.476%). A pump was used to drive the feed through the filtration module. The test was performed for 5 minutes.

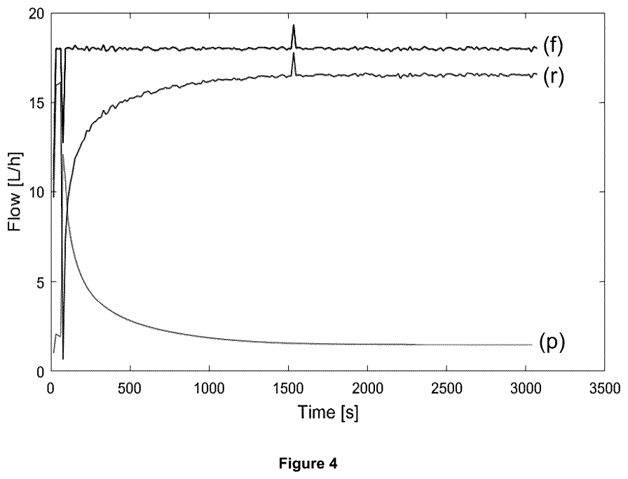

The results are shown in FIG. 4, where the flow of the feed (f), the permeate (p) and the retentate (r) are shown over time.

The results show that a steady-state plateau is obtained and remains constant at around 1.4 L/h for the permeate, when the feed was set to have a flow-rate of 18 L/h and the transmembrane pressure (TMP) is 3 bar.

### Example 1

A cross-flow filtration system was simulated having the same type of arrangement as shown in FIG. 1. The same type of filter membrane was used as in the Comparative Example, namely a polyethersulfone (PES) membrane (NX-Filtration™). The same testing device (Convergence Industry™ B.V.) was also used.

With the same liquid containing microplastic as the Comparative Example, a pulsatile laminar flow of the liquid was passed across the filter membrane, using the pump and the pressure limiter. The feed flow-rate was set to 18 L/h. The transmembrane pressure was 3 bar during the active phase and 0 bar during the inactive phase. The duty cycle was 80% with a 60 second active period. The pulse cycles that were produced are shown in FIG. 5, together with the results.

The result for operating the system with a conventional, continuous laminar flow of the feed is also shown (labelled “Pumping 60 min”).

It can be seen that the use of pulse cycles with a duty cycle of 80% produced superior results compared to operating the system with a conventional, continuous laminar flow (Comparative Example). Conventional operation of the system resulted in the flow rate reaching a plateau, with the mean permeate obtained during this plateau being about 1.4 L/h. In contrast, a mean permeate of 3.3 L/h was obtained using the pulsed protocol of the invention.

As the pump was not operated continuously during the pulsed protocol, the cross-flow filtration process of the invention is more energy efficient than the conventional process. The pressure limiter was used to prevent the excess pressure produced by the pump from being directly applied to the system. This excess pressure was redistributed within the system when the pump was switched off, which also improved energy efficiency.

The experiments have been successfully performed to remove larger particles having a particle size of 2.7 μm.

The experiments were also successfully carried out with a 140 kDa (pore size 4.44 nm) ceramic membrane, instead of a PES membrane. A similar improvement was also obtained for the ceramic membrane when using pulse cycles.

### Example 2

Further simulation experiments were carried out as in Example 1 to determine the effect of the duration of the active phase (e.g. the active period) on filtration.

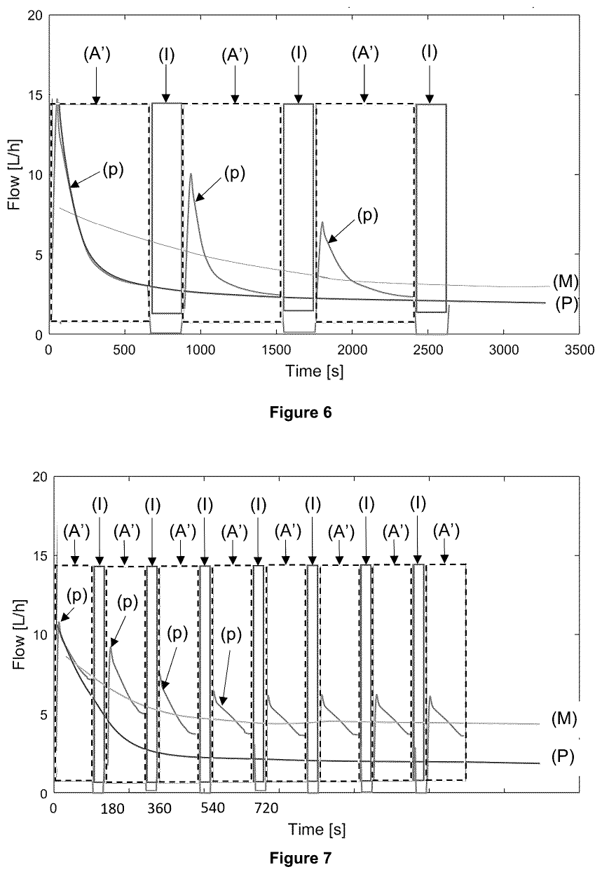

In a first experiment, the period of the pulse cycle was 15 minutes and the duty cycle was 80%. The transmembrane pressure was greater than 0 bar for 12 minutes (e.g. the duty pressure and the active period) and about 0 bar for 3 minutes (e.g. the inactive pressure and the inactive period). The results are shown in FIG. 6, which shows pulse cycles having an active phase (A′) and an inactive phase (I). The effect of these phases on the flow rate of permeate (p) is shown. The plateau (P) in the flow of permeate obtained from conventional cross-flow filtration without pulse cycles is also shown. The plateau (P) is also the asymptotic value of the exponential reduction of the throughput during each active phase.

In FIG. 6, it can be seen that when the active period is relatively long, then the flow of permeate in each individual active phase tends toward the plateau level (P). Nevertheless, an improvement in the mean value of permeate flow (M) over the plateau level (P) was still obtained.

In a second experiment, the period of the pulse cycle was 3 minutes and the duty cycle was 80%. The transmembrane pressure was greater than 0 bar for 144 seconds (e.g. the duty pressure and the active period) and about 0 bar for 36 seconds (e.g. the inactive pressure and the inactive period). The results are shown in FIG. 7. Like FIG. 6, FIG. 7 also shows the active phase (A′) and the inactive phase (I) of the pulse cycles. The effect of these phases on the flow rate of permeate (p) is shown. The plateau (P) in the flow of permeate obtained from conventional cross-flow filtration without pulse cycles is also shown.

When the active period is shorter, as shown in FIG. 7, then the flow of permeate in each individual active phase does not have time to reach the plateau level (P). This results in a further improvement in the mean value of permeate flow (M) that is obtained, when compared to the plateau level (P) and also to the relatively long active period used in FIG. 6. In other words by adjusting the duration of the active phase to a value significantly shorter than the time needed for reaching the plateau level (P) the part of the active phase with low throughput is cut away.

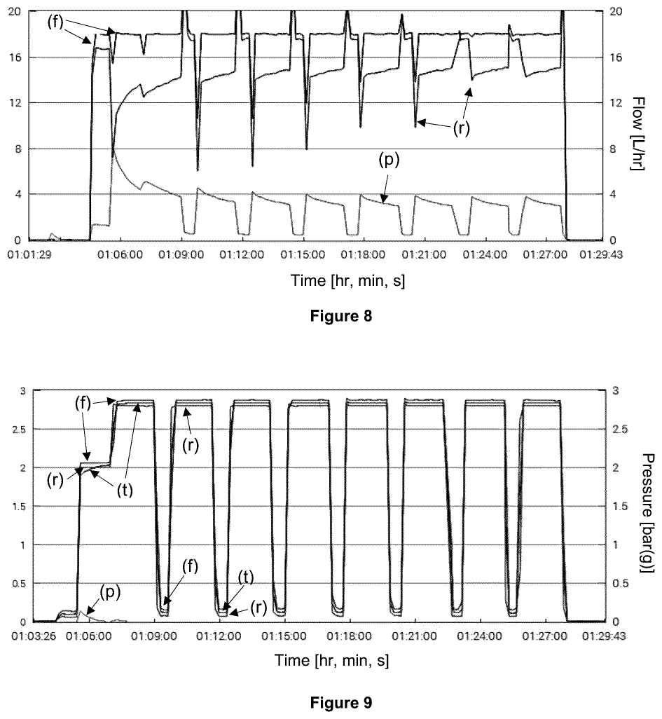

For completeness, FIGS. 8 and 9 are included from the same experiment. FIG. 8 shows the flow of feed (f), retentate (r) and permeate (p). FIG. 9 shows the pressures of the feed (f), retentate (r), permeate (p) and the transmembrane pressure (t). By comparing the graph in FIG. 8 with the graph in FIG. 9, the relationships between the individual flow rates and pressure can be seen.

### Example 3

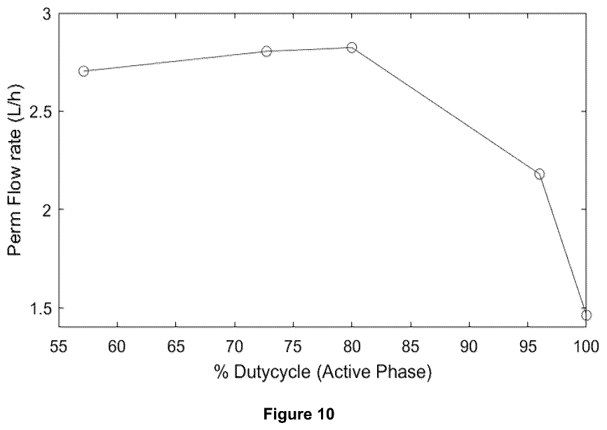

The experiment with the pulsed protocol in Example 1 was repeated, except that the active period for these experiments was set to 2 minutes and inactive period was either 5 s, 30 s, 45 s or 90 s. The duty cycle for each of these pulsatile waves was plotted against the permeate flow rate. The results are shown in FIG. 10.

From the analysis, it was found that a duty-cycle of around 80% leads to the highest filtration rate with the parameters and system used.

To understand the effects of parameters relating to the filter membrane on the flow of the liquid feed, a series of routine experiments were performed. These experiments confirmed that a laminar flow regime was present in all of the examples herein.

Reynolds numbers (Re) are closely related to the flow velocity in the fibres of the filter membrane. A change in fibre diameter, in the total number of fibres (filter membrane surface area) or in the feed flow rate can change the Reynolds number.

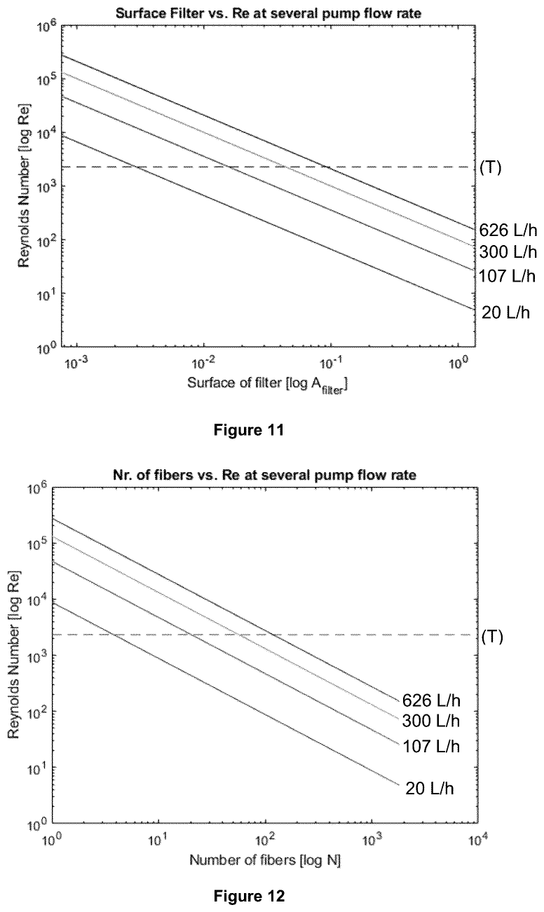

FIG. 11 is a graph showing the relationship between Reynolds number and filter membrane surface area at different liquid feed flow rates. The dashed line (T) is at a Reynolds number of around 2300, which separates the laminar regime (Re<2300) from the turbulent regime (Re>2300).

FIG. 12 is a graph showing the relationship between the Reynolds number and the number of fibers, when the fibers have a diameter of 0.7 mm.

The filter membranes used in the examples were PES membranes with 120 or 504 fibers and an inner diameter of about 0.8 mm. The membrane surfaces are 0.071 m² and 0.3 m², respectively. With a feed flow rate of 20 L/h, the system is in a deep laminar regime (Re<70). To achieve a turbulent regime, the feed flow rate would need to be >625 L/h.

### REFERENCE NUMERALS

The following reference numerals are used in the figures.

| | |
|---|---|
| 1 | sensor for detecting overflow |
| 2 | sensor for detecting a maximum fill level |
| 3 | sensor for detecting a minimum amount of feed |
| 5 | conduit for the feed of wastewater |
| 10 | pump |
| 15 | conduit for the permeate |
| 20 | filter module |
| 25 | filter membrane (25) |
| 30 | flow inhibitor, such as a pressure limiter |
| 35 | conduit for the retentate |
| 40 | container |
| 50 | prefilter |
| 60 | flow sensor |
| 65 | conduit connector |
| 70 | sensor for detecting a flow rate of the wastewater, such |
| | as a pressure sensor |
| 75 | bypass valve |
| 80 | controller |
| 85 | bypass conduit |
| 90 | flow switch |
| S1 | signal from sensor 1 for detecting overflow |
| S2 | signal from sensor 2 for detecting a maximum fill level |
| S3 | signal from sensor 3 for detecting a minimum amount of feed |
| S10 | signal from the controller 80 to the pump 10 |
| S60 | signal from the flow sensor 60 to the controller 80 |
| S70 | signal from sensor 70 to the controller 80 |
| S95 | signal from controller 80 to flow switch 90 |
| 100 | active pulse |
| 200 | flow peak |
| 300 | steep rising edge |
| 400 | falling edge |
| A′ | active phase |
| I | inactive phase |
| p | permeate |
| r | retentate |
| f | feed |
| t | transmembrane pressure |
| P | plateau level of permeate flow |
| M | mean value of permeate flow |
| T | threshold separating laminar and turbulent flows |

All headings and sub-headings are used herein for convenience only and should not be construed as limiting the invention in any way.

The use of any and all examples, or exemplary language (e.g. “such as”) provided herein, is intended merely to better illuminate the invention and does not pose a limitation on the scope of the invention unless otherwise paragraphed. No language in the specification should be construed as indicating any non-paragraphed element as essential to the practice of the invention.

This invention includes all modifications and equivalents of the subject matter recited in the paragraphs appended hereto as permitted by applicable law.

This patent application claims the priority of the European patent application 22157842.0, wherein the content of this European patent application is hereby incorporated by references.

1. A method of cross-flow filtering wastewater from a diagnostic apparatus or a laboratory analyser, wherein the wastewater comprises nanoparticles and/or microparticles, and the wastewater is flowing in a laminar flow across an inner surface of a tubular filter membrane having an inlet and an outlet at a flow rate such that a Reynolds number (Re) of the flowing wastewater is smaller than 500;
wherein the wastewater flows in pulse cycles across the inner surface of the tubular filter membrane from the inlet towards the outlet, wherein each pulse cycle comprises one active phase in which the wastewater is under a duty pressure at the inlet and one inactive phase in which the wastewater is under an inactive pressure at the inlet, wherein the inactive pressure is no more than 10% of the duty pressure and the active phases have a duration of greater than 50% of the corresponding pulse cycles; and
wherein a filtrate portion of the wastewater passes across the tubular filter membrane and wherein the nanoparticles and/or microparticles are separated from the filtrate portion of the wastewater by the tubular filter membrane.

2. The method according to claim 1, wherein a transmembrane pressure (TMP) in the active phase is 0.5 to 10.0 bar.

3. The method according to claim 1, wherein the nanoparticles and/or the microparticles are monodisperse.

4. The method according to claim 1, wherein the duration of the active phases does not exceed 90% of the corresponding pulse cycles.

5. The method according to claim 1, wherein the pulse cycles have a frequency of from 0.0015 Hz to 0.0100 Hz.

6. The method according to claim 1, wherein the duration of the active phase is not more than 80% of the time needed to reach the time it takes for flow throughput of permeate to drop from a maximum flow throughput of permeate in the active phase to a steady state flow throughput of permeate.

7. The method according to claim 1, further comprising:
adjusting a frequency of the pulse cycles to optimise flow throughput of permeate, and/or adjusting the duration of the active phase to optimise the efficiency of the filtering with respect to flow throughput of permeate and/or energy consumption.

8. The method according to claim 1, wherein the method further comprises:
(A) applying a recovery phase in which there is nearly no wastewater flow and there is nearly no transmembrane pressure; and
(B) applying a cleaning phase in which the wastewater is streamed across the surface of the filter membrane with nearly no transmembrane pressure;
wherein the recovery phase and the cleaning phase may be repeated several times.

9. A cross-flow filtration system for filtering wastewater from a diagnostic apparatus or a laboratory analyser, wherein the wastewater comprises nanoparticles and/or microparticles, by a laminar flow across an inner surface of a tubular filter membrane having an inlet and an outlet, the system comprising:
a filter module comprising the tubular filter membrane;
a pressure source for streaming wastewater across the surface of the tubular filter membrane from the inlet towards the outlet;
a sensor for detecting a flow rate of the wastewater;
a controller connected to the sensor and configured to control the pressure source to carry out a method according to claim 1; and
a flow inhibitor being disposed downstream of the filter module on a retentate side thereof, for providing a flow resistance during active phases of pulse cycles.

10. The cross-flow filtration system according to claim 9, wherein the flow inhibitor is:
a pressure limiter, or
a flow resistance means having a switchable bypass under the control of the controller, or
a controllable valve under the control of the controller.

11. The cross-flow filtration system according to claim 9, wherein the filter membrane is a hollow fiber membrane and/or the tubular membrane filter comprises a polymer or a ceramic material.

12. The cross-flow filtration system according to claim 9, wherein the tubular filter membrane has a pore size of at least 0.5 nm.

13. The cross-flow filtration system according to claim 9, wherein the tubular filter membrane has a pore size of not more than 25 μm.

14. The cross-flow filtration system according to claim 9, wherein the pressure source is a pump.

15. The cross-flow filtration system according to claim 9, wherein the sensor is disposed upstream of an inlet to the filter module.

16. The method according to claim 3, wherein the nanoparticles have a particle size of from 1 nm to 999 nm and/or the microparticles have a particle size of from 1000 nm to 5000 μm.

17. The method according to claim 4, wherein the duration of the active phases does not exceed 80%.

18. The method according to claim 5, wherein the pulse cycles have a frequency of from 0.0025 Hz to 0.0075 Hz.

19. The cross-flow filtration system according to claim 14, wherein the pressure source is a membrane pump.

20. The cross-flow filtration system according to claim 15, wherein the sensor is a pressure sensor or a flow sensor.
